(19) United States
(12) Patent Application Publication
(10) Pub. No.: US 2023/0397641 A1
(43) Pub. Date: Dec. 14, 2023

(54) GRINDABLE CULINARY BEADS FOR FLAVOURING FOOD

(71) Applicant: Lee WRIGHT, Wimbish Essex (GB)

(72) Inventor: Lee WRIGHT, Wimbish Essex (GB)

(21) Appl. No.: 18/250,386

(22) PCT Filed: Oct. 25, 2021
(86) PCT No.: PCT/GB2021/052773

§ 371 Date: Apr. 25, 2023

(30) Foreign Application Priority Data
Oct. 26, 2020 (GB) 2016796.9

(51) Int. Cl. A23L 27/14; A23L 27/00; A23L 27/12; A23L 3/44; A23P 10/20; A23P 20/18

(52) U.S. Cl. CPC A23L 27/14; A23L 27/72; A23L 27/12; A23L 3/44; A23P 10/20; A23P 20/18

(57) ABSTRACT

There is described a grindable spherical or substantially spherical culinary bead, comprising at least one comestible powder, a carrier powder, a starter core, a binding agent, at least one essential flavour oil, and a liquid solution. The bead can be ground to provide flavouring to food or beverages. There is also described methods of producing said product.

### FIELD OF THE INVENTION

This invention relates to a product which can be used to provide flavouring to food or beverages, and methods of producing said product.

### BACKGROUND OF THE INVENTION

Flavours provide food or beverages with their distinctive taste. Flavour is the property produced by the sensation of taste, or the combination of taste and smell. There are four basic tastes: sweet, salty, sour and bitter, which can be detected by taste buds present on the human tongue.

An extensive variety of flavours are available, including both artificial and natural flavours. Natural flavours may be derived from plant or animal sources, for example fruits, vegetables, herbs, spices, botanicals or essential oils and their extracts.

It is often desirable to alter the taste of food or beverages, for example by seasoning with salt or pepper. Hence, there exists a need to add different flavours from the extensive range of natural flavours available to food or beverages immediately prior to or during consumption.

The present invention relates to a grindable spherical or substantially spherical culinary bead comprising at least one essential flavour oil. The bead can be ground to introduce flavour into food or beverages. The present invention also relates to methods of production of a grindable spherical or substantially spherical culinary bead.

### SUMMARY OF THE INVENTION

The present invention is a grindable spherical or substantially spherical culinary bead comprising at least one comestible powder, a carrier powder, a starter core, a binding agent, and at least one essential flavour oil. The beads are particularly useful for introducing flavour into food or beverages prior to or during consumption.

In a preferred embodiment, the beads have a cellulose coating.

In a preferred embodiment, the grindable spherical or substantially spherical culinary bead comprises a starter core and at least four layers thereon, wherein the first layer comprises a binding agent, the second layer comprises at least one comestible powder, the third layer comprises atomised encapsulated liquid flavours in liquid solution, and the fourth layer comprises at least one carrier powder comprising encapsulated liquid flavours.

The present invention also relates to methods of production of a grindable spherical or substantially spherical bead.

A first method comprises at least the steps of: encapsulating at least one essential flavour oil within a starter core, spraying the starter core with a binding agent, spraying at least one comestible powder and a carrier powder onto the surface of the starter core to produce a layered sphere, and drying the sphere, to provide a grindable bead.

An alternative method comprises at least the steps of: mixing at least one comestible powder, a carrier powder, a binding agent, and at least one essential flavour oil together, extruding the mixture through an aperture having a diameter in the range of 2-10 mm, separating the extruded mixture into smaller portions, rotating each portion at high speed in a rotary drum to form a sphere, and drying each sphere, to provide a grindable bead.

A further alternative method comprises the steps of:
alternating layers of a liquid binding agent, at least one comestible powder, atomised encapsulated liquid flavours in liquid solution, and at least one carrier powder comprising encapsulated liquid flavours onto a starter core to provide a sphere; blast freezing the sphere; and drying the sphere using low temperature drying techniques to provide a grindable bead.

### DETAILED DESCRIPTION

According to a first aspect of the present invention, there is provided a grindable spherical or substantially spherical culinary bead, comprising at least one comestible powder, a carrier powder, a binding agent, at least one essential flavour oil, and a liquid solution.

The bead is capable of being ground by any suitable device, for example a peppercorn grinder, or pestle and mortar. Grinding may be carried out by hand or using mechanical means.

The beads are spherical or substantially spherical in shape. The shape of the beads is such that all points of the bead surface are equidistant or substantially equidistant from the bead centre.

The essential flavour oil provides a source of flavour. Essential flavour oils are derived from plant material. It is widely recognised that essential oils provide very concentrated flavours. Even when used in small quantities, they offer a powerful flavour delivery. Freshly grinding herbs, spices, fruit or vegetables provides a sharp, clean, strong flavour.

A multitude of flavourings is available naturally. Some examples can include: chili, lemon, horseradish, beetroot, sage, onion, wasabi, ginger, tomato, basil, garlic, orange, peppermint, lime, thyme, oregano, rosemary, anise, bergamot, clove, eucalyptus, grapefruit, lavender, lemongrass, nutmeg, spearmint, tangerine, wintergreen or any combination thereof, as well as any other spice, herb, vegetable, fruit or botanical extracts, or any combination thereof.

Preferably, the flavouring may be a combination of flavours. Examples of flavour combinations can include: (i) Red Chilli & Lemon peel; (ii) Horseradish & Beetroot; (iii) Sage & Onion; (iv) Wasabi & Ginger; or (v) Tomato & Basil & Garlic.

The essential flavour oil may be provided as an encapsulated droplet or microdroplet. The encapsulated droplet is releasable from the encapsulating carrier powder upon contact with human tongue or by mastication.

The present invention provides a spherical or substantially spherical culinary bead which combines essential flavour oils with one or more of the group comprising: herbs, spices, fruits, vegetables, botanicals, or any combination thereof. The dried culinary bead may be freshly ground to deliver a powerful flavour.

The comestible powder can contribute to the flavour of the bead. The comestible powder comprises part of the flavour of the bead by adding natural flavouring in powdered form.

The comestible powder may also provide a natural source of nutrition. The comestible powder may comprise vitamins, minerals, or other nutraceutical benefits. The comestible powder may comprise nutraceuticals added to provide fortification, such as vitamins, minerals, and/or other dietary supplements such as proteins and essential amino acids. By way of example only, the comestible powder may comprise Vitamin D, iron, L-Leucine, L-Isoleucine or L-Valine.

The comestible powder may be selected from the group comprising: spice powders, vegetable powders, dried herbs, dried fruit, dried botanicals, or any combination thereof.

The carrier powder may be selected from the group comprising: yeast, gum Arabic, alginate, polysaccharide, starch, lipids, vegetable protein, xanthan gum, carrageenan gum, or any combination thereof.

The carrier powder may further comprise an essential flavour oil. The essential flavour oil can be present in the form of a droplet or microdroplet encapsulated within the carrier power.

The starter core may be selected from the group comprising: wheat flour, mustard seeds, chia seeds, starch beads, sugar beads, tartaric beads, mannitol beads, citric acid beads, malic acid beads, calcium carbonate beads, lactose beads, or any combination thereof.

The starter core may have a diameter within the range of 0.5 to 4 millimetres.

The binding agent may comprise water, starch, cellulose, sugar, acacia gum, alginate, 25 vegetable protein, carrageenan, chitosan, xanthan, polysaccharide, or any combination thereof. The binding agent may be used to bind the carrier powder and comestible powder(s) together as a spherical or substantially spherical bead, prior to drying.

The binding agent may further comprise at least one essential flavour oil.

Preferably, the binding agent is an emulsion.

The finished culinary grinding bead may have a diameter of approximately 2 to 10 millimetres. Preferably, the bead may have a diameter of 5 millimetres.

The bead may further comprise a cellulose coating. The cellulose coating may be up to 5% (w/w) of the dried sphere. Preferably, the coating is approximately 1% w/w of the dried sphere.

This coating is water proof and heat resistant. It is clear, tasteless and invisible. The coating provides a film-like layer on the surface of the spherical bead. The coating locks the flavour into the bead by preventing evaporation of the essential flavour oils at atmospheric conditions. The coating helps prolong the shelf-life of the bead and its associated flavour. The coating also prevents absorption of moisture by the bead. This is particularly useful when the bead is being ground over hot food, where steam is present. This is also useful for preventing absorption of atmospheric moisture by the bead during storage. This further extends shelf-life of the bead, and its flavour.

According to a further aspect of the present invention, there is provided a method of producing a grindable spherical or substantially spherical culinary bead.

The method comprises the steps of:
encapsulating at least one essential flavour oil within a starter core;
spraying the starter core with a binding agent;
spraying at least one comestible powder and a carrier powder onto the surface of the starter core to produce a layered sphere; and
drying the sphere;
to provide a grindable bead.

The comestible powder(s) and carrier powder may be sprayed onto the starter core in a rotary drum.

The spheres are dried using a fluid bed dryer or a drying oven.

According to a further aspect of the present invention, there is provided an alternative method of producing a grindable spherical or substantially spherical culinary bead.

The method comprises the steps of:
mixing at least one comestible powder, a carrier powder, a binding agent, and at least one essential flavour oil together;
extruding the mixture through an aperture having a diameter in the range of 2-10 mm;
separating the extruded mixture into smaller portions;
rotating each portion at high speed in a rotary drum to form a sphere; and
drying each sphere;
to provide a grindable bead.

The extruded mixture may be separated into smaller portions by chopping.

Each sphere may be dried in a fluid bed dryer or a drying oven.

The essential flavour oil may be encapsulated within the starter core. Encapsulation can be achieved through use of a bespoke machine comprising a vacuum chamber and ribbon blending arms. The machine is capable of facilitating mixing, warming, cooling, vacuum, and binding agent dispersion via a spray port.

The starter core may be selected from the group comprising: wheat flour, mustard seeds, chia seeds, starch beads, sugar beads, tartaric beads, mannitol beads, citric acid beads, malic acid beads, calcium carbonate beads, lactose beads, or any combination thereof.

The starter cores are placed inside the vacuum chamber, and are rotated by the blending arms. The starter cores may be sprayed or soaked with essential oils prior to vacuum. The chamber is placed under vacuum between −0.5 bar to −1.5 bar. The atmospheric gas within the chamber and the starter cores is removed. Essential oils on the surface of the starter core may be drawn into the micropores of the starter core.

The vacuum may then be released. Warm air may be blown into the chamber to further dry the starter cores, if desired.

The starter cores may then be transferred to the rotary drum.

Under rotation, the starter cores may be sprayed with a binding agent. The binding agent may comprise water, starch, cellulose, sugar, acacia gum, alginate, vegetable protein, carrageenan, chitosan, xanthan, polysaccharide, or any combination thereof.

The binding agent may further comprise an essential flavour oil.

Preferably, the binding agent is an emulsion. The emulsion may be created using a high shear or high speed mixer, or a high pressure homogeniser or a high powered ultrasound device.

The binding agent may be applied to the starter core(s) as a pneumatically atomised binder emulsion. This emulsion is finely sprayed onto the starter core(s) while at least one comestible powder and a carrier powder is simultaneously finely sprayed, poured, or shaken onto the starter core(s).

The starter core may be built up to form a spherical or substantially spherical bead by powder layering. As the binding agent, the comestible power(s) and the carrier powder combine on the surface of the starter core whilst the starter core is being spun in the rotary chamber, the layers of powder gradually build up on the surface of the starter core to form the spherical or substantially spherical bead.

The comestible powder(s) layered onto the surface of the starter core is selected from the group comprising: spice powders, vegetable powders, dried herbs, dried fruit, dried botanicals or any combination thereof.

The carrier powder layered onto the surface of the starter core is selected from the group comprising: yeast, gum Arabic, alginate, polysaccharide, starch, lipids, vegetable protein, xanthan gum, carrageenan gum, or any combination thereof.

Once the sphere reaches its desired diameter, the spheres are removed from the rotary chamber of the machine.

The spheres can be dried until hard to provide grindable spherical or substantially spherical beads. The spheres may be dried in a commercial drying oven. Preferably, the spheres are dried slowly at a low temperature to reduce evaporation of the essential oils. More preferably, the spheres are dried for a time period of 30 minutes to 4 hours, at a temperature between 18-38° C.

Optionally, the spheres may be further coated in an additional layer of carrier powder prior to drying. Preferably, the additional carrier powder layer comprises an encapsulated essential oil droplet. The encapsulated droplet is releasable from encapsulation upon contact with a human tongue, or by mastication.

The finished culinary grinding bead may have a diameter of approximately 2 to 10 millimetres. Preferably, the bead may have a diameter of 5 millimetres.

The method may further comprise the step of coating the sphere after the drying.

The coating comprises cellulose or a derivative thereof. The cellulose coating may be up to 5% (w/w) of the dried sphere. Preferably, the coating is approximately 1% w/w of the dried sphere. This coating is water proof and heat resistant.

The bead produced by the methods discussed is grindable. The bead may be ground onto foodstuffs or beverages to impart flavour.

According to a further aspect of the present invention, there is provided a further alternative method of producing a grindable spherical or substantially spherical culinary bead.

A further alternative method comprises the steps of: alternating layers of a liquid binding agent, at least one comestible powder, atomised encapsulated liquid flavours in liquid solution, and at least one carrier powder comprising encapsulated liquid flavours onto a starter core to provide a sphere; blast freezing the sphere; and drying the sphere using low temperature drying techniques to provide a grindable bead.

Each of the four substituents is individually prepared prior to application to the starter core in a pattern of alternating layers.

The starter core may be selected from the group comprising: wheat flour, mustard seeds, chia seeds, starch beads, sugar beads, tartaric beads, mannitol beads, citric acid beads, malic acid beads, calcium carbonate beads, lactose beads, or any combination thereof.

The starter core may have a diameter within the range of 0.5 to 4 millimetres.

The comestible powder(s) layered onto the surface of the starter core is selected from the group comprising: spice powders, vegetable powders, dried herbs, dried fruit, dried botanicals or any combination thereof.

The binding agent may comprise water, starch, cellulose, sugar, acacia gum, alginate, vegetable protein, carrageenan, chitosan, xanthan, polysaccharide, or any combination thereof. The binding agent may be used to bind the carrier powder and comestible powder(s) together as a spherical or substantially spherical bead, prior to drying.

Preferably, the binding agent is a liquid. The binding agent in liquid form can be sprayed onto the starter core.

Alternatively, the binding agent is a powder. The binding agent in powder form can be mixed with the comestible powder and/or carrier powder.

At least one essential flavour oil is atomised into microdroplets. The microdroplets may have a size of approximately one micron. The microdroplets can be formed by using an ultrasound probe, high shear homogenisation, or high pressure homogenisation.

Optionally, the microdroplets may contain at least one essential flavour oil, complex flavour oil, or flavour extract-Oleoresins, or any combination thereof.

Oleoresins are natural products that consist of a complex mixture of lipophilic molecules rich in bioactive metabolites that can be used as natural additives. They have pungency and aroma which can contribute to the taste of food products.

The microdroplets are incorporated into a liquid solution. The flavour oil is sheared using high speed blades with inset holes. This action chops the oil into microdroplets. As the liquid solution is aqueous, each of the microdroplets of oil are encompassed into the solution without being able to re-agglomerate

The liquid solution comprises at least one of the group comprising: solubilised gum, starch, and cellulose. This liquid solution subsequently forms a film membrane around the microdroplet of essential flavour oils and/or complex flavour oils and/or Oleoresins during the drying process.

At least one essential flavour oil is encapsulated into a dry powder format. The dry powder is a carrier powder selected from the group comprising: yeast, gum Arabic, alginate, polysaccharide, starch, lipids, vegetable protein, xanthan gum, carrageenan gum, or any combination thereof.

To achieve encapsulation, the essential oil(s) is diffused through the membrane wall of vegetative matter particles to encase the oil droplets within the vegetative matter. This takes place under the appropriate conditions, including temperature, time, and stirring rate.

The vegetative matter particle encapsulating the essential flavour oil(s) may subsequently be further encapsulated within a coating. The coating is selected from the group comprising: starch, gum and cellulose, or any combination thereof.

The coating acts in three ways. Firstly, it soaks up any oil remaining on the outside of the vegetative particle membrane wall. Secondly, it seals any open pores within the membrane wall, ensuring no flavour oil is leeched. Thirdly, it acts to assist the drying of the powder and the free flow attributes of the resulting dry powder.

The resultant powder formed is a dry flowing powder comprising at least one essential flavour oil.

The grindable spherical or substantially spherical culinary bead produced by the method comprises layers of the following substituents: a liquid binding agent, at least one comestible powder, atomised encapsulated liquid flavours in liquid solution, and at least one carrier powder comprising encapsulated liquid flavours.

The layers of these substituents protect the volatile essential flavour oils from evaporating. This preserves the flavour of the grindable bead to ensure impactful flavour delivery to the consumer.

The grindable spherical or substantially spherical bead produced via this method undergoes blast freezing and subsequent drying using low temperature drying techniques such as radiant freeze drying. This further protects the volatile essential flavour oils present within the grindable spherical bead. The use of freeze drying technology results in a harder drier spherical bead as there is less residual moisture in the resultant bead compared to oven-dried beads (between 1-2% residual moisture). This makes the bead easier to grind.

The invention outlined herein is further described in the following clauses:
1. A grindable spherical or substantially spherical culinary bead, comprising at least one comestible powder, a carrier powder, a starter core, a binding agent, and at least one essential flavour oil.
2. A bead according to clause 1, wherein the comestible powder is selected from the group comprising: spice powders, vegetable powders, dried herbs, dried fruit, dried botanicals, or any combination thereof.
3. A bead according to clause 1, wherein the carrier powder is selected from the group comprising: yeast, gum Arabic, alginate, polysaccharide, starch, lipids, vegetable protein, xanthan gum, carrageenan gum, or any combination thereof.
4. A bead according to clause 3, wherein the carrier powder further comprises an essential flavour oil.
5. A bead according to clause 1, wherein the starter core is selected from the group comprising: wheat flour, mustard seeds, chia seeds, starch beads, sugar beads, tartaric beads, mannitol beads, citric acid beads, malic acid beads, calcium carbonate beads, lactose beads, or any combination thereof.
6. A bead according to clause 1, wherein the binding agent comprises water, starch, cellulose, sugar, acacia gum, alginate, vegetable protein, carrageenan, chitosan, xanthan, polysaccharide, or any combination thereof.
7. A bead according to clause 6, wherein the binding agent is an emulsion.
8. A bead according to clause 6, wherein the binding agent further comprises at least one essential flavour oil.
9. A bead according to any preceding clause, wherein the essential flavour oil is provided in the form of an encapsulated droplet or microdroplet.
10. A bead according to clause 1, having a diameter within the range of 2 to 10 mm.
11. A bead according to clause 1, further comprising a cellulose coating.
12. A method of producing a bead according to clause 1, comprising the steps of:
   encapsulating at least one essential flavour oil within a starter core;
   spraying the starter core with a binding agent;
   spraying at least one comestible powder and a carrier powder onto the surface of the starter core to produce a layered sphere; and
   drying the sphere;
   to provide a grindable bead.
13. A method according to clause 11, wherein the comestible powder and carrier powder are sprayed onto the starter core in a rotary drum.
14. A method according to clause 11, wherein the sphere is dried using a fluid bed dryer or a drying oven.
15. A method of producing a bead according to clause 1, comprising the steps of:
   mixing at least one comestible powder, a carrier powder, a binding agent, and at least one essential flavour oil together;
   extruding the mixture through an aperture having a diameter in the range of 2-10 mm;
   separating the extruded mixture into smaller portions;
   rotating each portion at high speed in a rotary drum to form a sphere; and drying each sphere;
   to provide a grindable bead.
16. A method according to clause 15, wherein each sphere is dried in a fluid bed dryer or a drying oven.
17. A method according to any of clauses 11-15, further comprising a coating step, whereby a cellulose coating is applied to the surface of the dried sphere by spraying.
18. A method according to clause 17, wherein the cellulose coating is up to 5% (w/w) of the dried sphere.
19. A method according to clause 17, wherein the cellulose coating is approximately 1% (w/w) of the dried sphere.
20. A method according to any of clauses 11-15, wherein the starter core has a diameter within the range of 0.5-4 mm.

### Example 1

A bead according to the present invention can provide a “Red Chilli and Lemon Peel” flavour, and have the following composition:

| | Ingredients |
|---|---|
| Starter Core | Mustard seed, Mustard seed oil, Lemon peel oil |
| Binding agent (emulsion) | Water, Maltodextrin, Hydroxy Propyl Methyl Cellulose, Mustard |
| | seed oil, Lemon peel oil |
| Comestible Powers | Red Chilli powder, Lemon Peel powder, Onion Powder, |
| | Cayenne powder, Sea Salt, Caster sugar, Paprika, Garlic |
| | powder, Citric acid, Silicon Dioxide |
| Carrier Powder | Maltodextrin, Mustard seed oil, Lemon Peel oil, Yeast |
| Final sphere coating | Ethyl Cellulose, Hydroxy Propyl Methyl Cellulose |

1. A grindable spherical or substantially spherical culinary bead, comprising at least one comestible powder, a carrier powder, a starter core, a binding agent, at least one essential flavour oil, and a liquid solution.

2. A bead according to claim 1, wherein the comestible powder is selected from the group comprising: spice powders, vegetable powders, dried herbs, dried fruit, dried botanicals, or any combination thereof.

3. A bead according to claim 2, wherein the comestible powder further comprises nutritional powders selected from the group comprising: vitamins, minerals, proteins, and essential amino acids, or any combination thereof.

4. A bead according to claim 1, wherein the carrier powder is selected from the group comprising: yeast, gum Arabic, alginate, polysaccharide, starch, lipids, vegetable protein, xanthan gum, carrageenan gum, or any combination thereof.

5. A bead according to claim 4, wherein the carrier powder further comprises an essential flavour oil.

6. A bead according to claim 1, wherein the starter core is selected from the group comprising: wheat flour, mustard seeds, chia seeds, starch beads, sugar beads, tartaric beads, mannitol beads, citric acid beads, malic acid beads, calcium carbonate beads, lactose beads, or any combination thereof.

7. A bead according to claim 1, wherein the binding agent is selected from the group comprising: water, starch, cellulose, sugar, acacia gum, alginate, vegetable protein, carrageenan, chitosan, xanthan, polysaccharide, or any combination thereof.

8. A bead according to claim 7, wherein the binding agent is an emulsion.

9. A bead according to claim 7, wherein the binding agent is a liquid.

10. A bead according to claim 7, wherein the binding agent further comprises at least one essential flavour oil.

11. A bead according to claim 1, wherein the essential flavour oil is provided in the form of an encapsulated droplet or microdroplet.

12. A bead according to claim 1, having a diameter within the range of 2 to 10 mm.

13. A bead according to claim 1, further comprising a cellulose coating.

14. A bead according to claim 1, comprising the starter core and at least four layers thereon, wherein the first layer comprises the binding agent, the second layer comprises the at least one comestible powder, the third layer comprises atomised encapsulated liquid flavours in liquid solution, and the fourth layer comprises at least one carrier powder comprising encapsulated liquid flavours.

15. A bead according to claim 14, wherein the liquid solution comprises at least one of the group comprising: solubilised gum, starch, and cellulose.

16. A bead according to claim 14, wherein the atomised encapsulated liquid flavours are microdroplets having a size of approximately one micron.

17. A bead according to claim 16, wherein the microdroplets contain at least one essential flavour oil, complex flavour oil, or flavour extract-Oleoresins, or any combination thereof.

18. A bead according to claim 14, wherein the fourth layer comprises a carrier powder selected from the group comprising: yeast, gum Arabic, alginate, polysaccharide, starch, lipids, vegetable protein, xanthan gum, carrageenan gum, or any combination thereof.

19. A bead according to claim 18, wherein the carrier powder further comprises a coating, wherein the coating is selected from the group comprising: starch, gum and cellulose, or any combination thereof.

20. A method of producing a bead comprising one comestible powder, a carrier powder, a starter core, a binding agent, at least one essential flavour oil, and a liquid solution, the bead comprising the starter core and at least four layers thereon, wherein the first layer comprises the binding agent, the second layer comprises the at least one comestible powder, the third layer comprises atomised encapsulated liquid flavours in liquid solution, and the fourth layer comprises at least one carrier powder comprising encapsulated liquid flavours, the method comprising the steps of:
alternating layers of a liquid binding agent, at least one comestible powder, atomised encapsulated liquid flavours in liquid solution, and at least one carrier powder comprising encapsulated liquid flavours onto a starter core to provide a sphere;
blast freezing the sphere; and
drying the sphere using low temperature drying techniques to provide a grindable bead.

21. A method according to claim 20, wherein the at least four layers are sprayed onto the starter core in a rotary drum.

22. A method according to claim 20, wherein the sphere is dried by freeze drying.
